(19) United States
(12) Patent Application Publication
(10) Pub. No.: US 2010/0229298 A1
(43) Pub. Date: Sep. 16, 2010

(54) TRANSFER MATTRESS WITH INFLATABLE FOOT REST

(75) Inventor: David T. Davis, Bethlehem, PA (US)

Correspondence Address: DUANE MORRIS LLP - Philadelphia;IP DEPARTMENT, 30 SOUTH 17TH STREET, PHILADELPHIA, PA, 19103-4196, US

(73) Assignee: WOODLARK CIRCLE, INC., Bethlehem, PA (US)

(21) Appl. No.: 12/407,505

(22) Filed: Mar. 19, 2009

Related U.S. Application Data
(60) Provisional application No. 61/159,969, filed on Mar. 13, 2009.

(51) Int. Cl. A61G 7/00; A47C 27/08; A47C 27/10; A47C 20/04

(52) U.S. Cl. 5/81.1 R; 5/706; 5/710; 5/655.3; 5/652

(57) ABSTRACT

An inflatable mattress is provided that includes a top panel having a top surface, and a bottom panel having a plurality of perforations defined therethrough. The bottom panel is sealingly assembled to the top panel. An inflatable foot rest is attached to the top surface of the top panel and is suitable for raising at least one leg of a patient when the patient is lying upon the top panel.

This application claims priority from, and the benefit of U.S. provisional patent application Ser. No. 61/159,969, filed Mar. 13, 2009, entitled TRANSFER MATTRESS WITH INFLATABLE FOOT REST, which is incorporated herein by reference.

### FIELD OF THE INVENTION

The present invention generally relates to air mattresses, and more particularly to air mattresses with an inflatable foot rest for elevating a patient's legs.

### BACKGROUND OF THE INVENTION

It is well known in the medical arts that some procedures require the patient's lower body to be elevated. In some instances, the procedure may require the elevation of the patient's lower body for a time. For example, constant elevation of a patient's lower body may relieve symptoms associated with swelling or bleeding in the lower extremities. In another example, it may be desirable to keep a patient's legs elevated and stabilized during transport between examination rooms. In yet another example, the elevation of the lower body would assist the placement of a bedpan under a patient's body. Typical prior art foot rests are not integrated into a transfer mattress, thus requiring repositioning of the patient's legs when the patient is moved between mattresses. Examples of such prior art foot rests may be found in U.S. Pat. Nos.: 3,308,489; 4,829,614; 5,809,597; and 5,012,539 which patents are incorporated herein by reference.

Patient handling mattresses are known in the art which include at least two flexible material sheets, that together define a plenum chamber, with at least one sheet being perforated with small pinholes over at least a central surface area, and which open up directly to the interior of the plenum chamber. Such prior art mattresses are used by arranging the perforated sheet so that it faces an underlying fixed, generally planar support surface, such as a floor or table. When the mattress is charged with pressurized air, the escape of air under pressure through the pinholes acts initially to jack a load placed upon the mattress above the perforated flexible sheet, and thereby creates an air bearing of relatively small height between the underlying fixed, generally planar support surface and the perforated flexible sheet. Examples of prior art transfer mattresses may be found in U.S. Pat. Nos.: 4,054,960; 4,272,856; 4,517,690; 4,627,426; 5,065,464; 5,483,709; RE35,299; 5,561,873; 5,594,962;5,598,593; 5,742,958; 6,073,291; 6,374,435; 6,415,583; 6,418,579; 6,677,026; 6,684,434; 6,687,935; 6,760,939; 6,857,143; 6,898,809, and published patent application No. 2002/0166168, which patents and applications are incorporated herein by reference.

Human knee, ankle and foot joints permit a very wide range of positioning of the foot with respect to the leg. When bandaging or setting in casts, however, it is necessary to select a specific leg/foot joint orientation and then maintain the selected positioning while the bandage material is applied. Often, this selected position requires supporting the leg at the heel, adjacent to the calcaneus. The difficulties of supporting a patient's leg in the foregoing manner, and maintaining the selected positioning during examination, treatment, or bandaging are exasperated if the patient is obese.

There is a need in the art for an inflatable transfer mattress that allows for easy positioning of a patient while maintaining constant leg elevation, and particularly where only the heel of the patient can be supported as a result of the need by the clinician to access the entire leg of the patient.

### SUMMARY OF THE INVENTION

The present invention provides an inflatable mattress that includes a top panel having a top surface, and a bottom panel having a plurality of perforations defined therethrough, the bottom panel being sealingly assembled to the top panel. An inflatable foot rest is attached to the top surface and is suitable for raising at least one leg of a patient when the patient is lying upon the top panel.

In one embodiment of the invention, an inflatable mattress is provided that includes a top panel having a top surface and a peripheral edge, and a bottom panel having a plurality of perforations defined therethrough and a peripheral edge. The bottom panel is sealingly assembled to the top panel. An inflatable foot rest is attached to the top surface of the top panel, and is suitable for raising at least one leg of a patient when the patient is lying upon the top panel. The inflatable foot rest includes a top panel, a bottom panel, and a perimeter band having a top edge and a bottom edge. The top and bottom panels are arranged with the perimeter band so as to define a first air chamber and second air chamber within the inflatable footrest. The perimeter band often tapers toward a central transverse axis so that the top edge and the bottom edge of the perimeter band may be sealingly fastened to the peripheral edges of the top panel and the bottom panel.

A method is also provided for elevating the legs of a patient. The method includes positioning a transfer mattress on a surface suitable for supporting the patient. The transfer mattress comprises a top panel having a foot rest in a deflated position attached thereon. The patient is positioned on the top panel whereby at least one foot of the patient is supported by the foot rest. As air fills at least one air chamber of the foot rest, the foot rest expands from a deflated position to an inflated position, thereby raising at least one foot of the patient to a desired height above the top panel.

Another method is provided for transferring the patient while the patient's feet are in an elevated position. The method includes positioning a transfer mattress on a surface suitable for supporting the patient. The transfer mattress comprises a top panel having a foot rest in a deflated position attached thereon, and a bottom panel having a plurality of holes therethrough. The patient is positioned on the top panel whereby at least one foot of the patient is supported by the foot rest. As a supply of air fills at least one air chamber the foot rest expands from a deflated position to an inflated position, thereby raising at least one foot of the patient to a desired height above the top panel. The transfer mattress is then inflated with a pressurized air source such that air will flow through the plurality of holes in the bottom panel thus creating a cushion of air necessary for transferring the patient. Once inflated, the transfer mattress is shifted laterally from a first position to a second position. Once in the second position, the air supply is stopped while at least one foot of the patient remains at the desired height.

Another method is provided for transferring the patient while the patient's legs are not elevated. The method includes positioning a transfer mattress on a surface suitable for supporting the patient. The transfer mattress comprises a top panel having a foot rest in a deflated position attached thereon, and a bottom panel having a plurality of holes therethrough. The patient is positioned on the top panel. As a supply of air fills the transfer mattress, air will flow through the plurality of holes in the bottom panel thus creating a cushion of air necessary for transferring the patient. Once inflated, the transfer mattress is shifted laterally from a first position to a second position.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a perspective view of the transfer mattress and foot rest formed in accordance with the present invention;

FIG. 2 is a top view of the transfer mattress and foot rest formed in accordance with the present invention;

FIG. 3 is a side view of the transfer mattress and foot rest in a fully inflated position formed in accordance with the present invention;

FIG. 4 is a perspective view of the foot rest formed in accordance with the present invention;

FIG. 5 is a top view of the foot rest formed in accordance with the present invention;

FIG. 6 is a front view of the foot rest formed in accordance with the present invention;

FIG. 7 is a side view of the foot rest formed in accordance with the present invention;

FIG. 8 is a perspective view of the foot rest formed in accordance with the present invention;

FIGS. 8a-8e are a perspective views of an alternative embodiment comprising separate cushions that may be attached to one another to form a foot rest in accordance with the present invention;

FIG. 9 is a perspective view of the foot rest formed in accordance with one embodiment of the present invention;

FIG. 10 is a perspective view of the transfer mattress and the foot rest formed in accordance with another embodiment of the present invention;

FIG. 10a is a perspective view of an alternative embodiment showing a transfer mattress and a removable foot rest formed in accordance with the present invention; and

FIG. 11 is a side view of the transfer mattress in an inflated position and foot rest in a deflated position in accordance with the present invention.

### DETAILED DESCRIPTION

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses, if used, are intended to cover the structures described, suggested, or rendered obvious by the written description or drawings for performing the recited function, including not only structural equivalents but also equivalent structures.

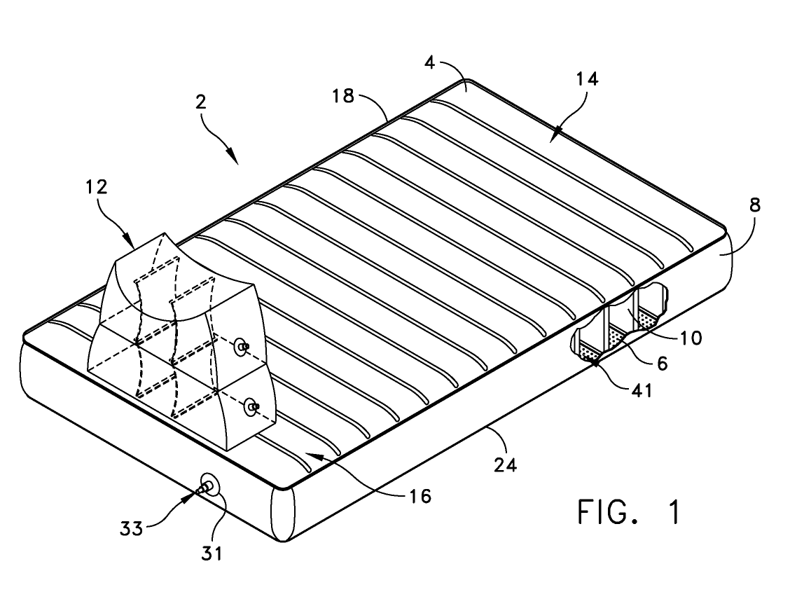

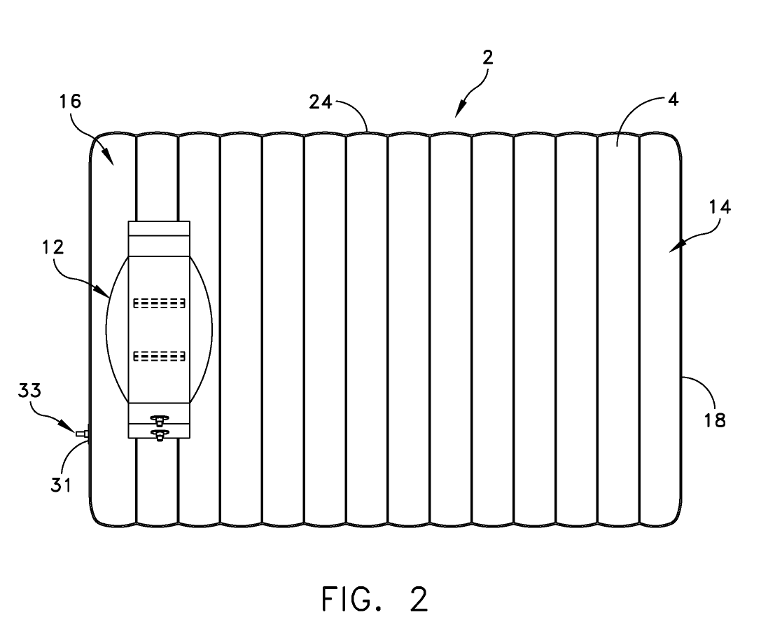

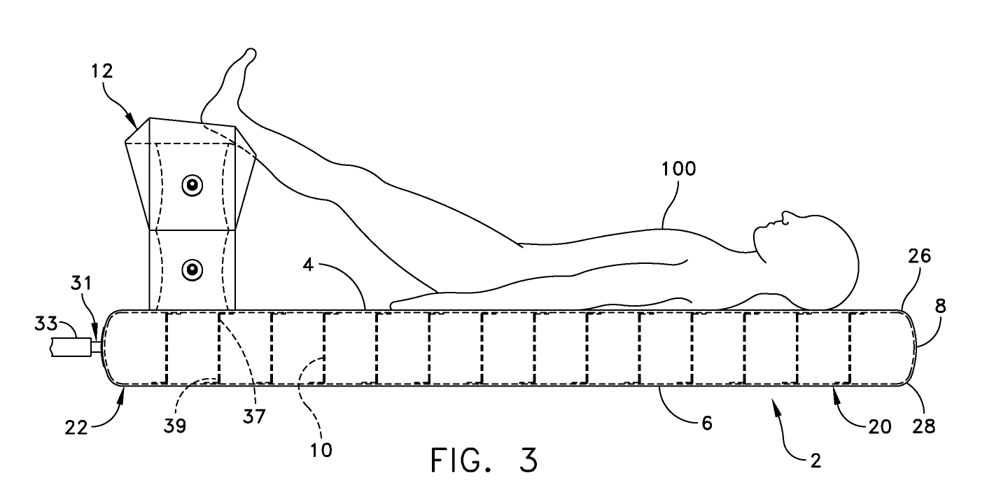

Referring to FIGS. 1-3, a transfer mattress 2 is provided including a top panel 4, a bottom panel 6, a perimeter band 8, a plurality of baffle-panels 10, and a foot rest 12. Top panel 4 comprises a head portion 14, a foot portion 16, and a peripheral edge 18. Likewise, bottom panel 6 comprises a head portion 20, a foot portion 22, and a peripheral edge 24, and is substantially similar in peripheral profile to top panel 4 (FIG. 3). Perimeter band 8 often comprises an elongate substantially rectangular strip, having a top edge 26 and a bottom edge 28 (FIG. 3). In preferred embodiments of the invention, top panel 4 and bottom panel 6 are substantially the same in size and peripheral outline so that top edge 26 and bottom edge 28 of perimeter band 8 may be sealingly fastened to peripheral edges 18 and 24.

An inlet opening 31 is formed in a portion of perimeter band 8, between peripheral edges 26 and 28, and may be a closable opening that sealingly accepts an air supply hose 33. Inlet opening 31 is sized and shaped so that air supply hose 33 may be inserted, with the inlet being thereafter snapped shut or otherwise closed to hold air supply hose 33 in place while transfer mattress 2 is being inflated. Inlet opening 31 may also include a valve (not shown) that is biased to be normally closed to prevent air from exiting through the inlet, and opened when air supply hose 33 is inserted into inlet opening 31. Other arrangements known to those skilled in the art may be used to inflate transfer mattress 2.

Bottom panel 6 includes a plurality of tiny holes 41 (FIG. 1) that are defined through its thickness to allow air, that is supplied by a pressurized air supply to transfer mattress 2, via air supply hose 33, to escape in a controlled manner. The air supplied to a transfer mattress 2 escapes through plurality of holes 41, providing a weight-bearing cushion of air that facilitates the sliding of transfer mattress 2 along a surface, as well as, from one surface to another.

Plurality of baffle-panels 10 each comprise substantially rectangular sheets of nylon scrim or the like, and include a top edge 37 and a bottom edge 39 (FIG. 3). Baffle-panels 10 may have differing or varying widths, depending upon their position within transfer mattress 2. Each top edge 37 may be fastened transversely or longitudinally (not shown) or to a portion of the inner surface of top panel 4, and each bottom edge 39 may be fastened transversely or longitudinally (not shown) or to a portion of the inner surface of bottom panel 6. When baffle-panels 10 are assembled in a transverse manner, they may often have a narrow center section that causes at least top panel 4 to form a longitudinally oriented concave recess which helps to cradle a patients legs when transfer mattress 2 is inflated with air. A similar concave recess is formed when baffle-panels 10 are assembled in a longitudinal manner.

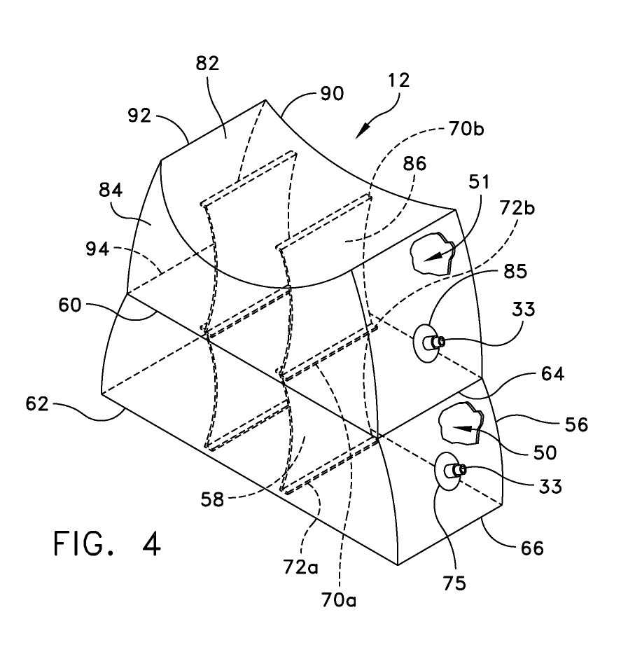

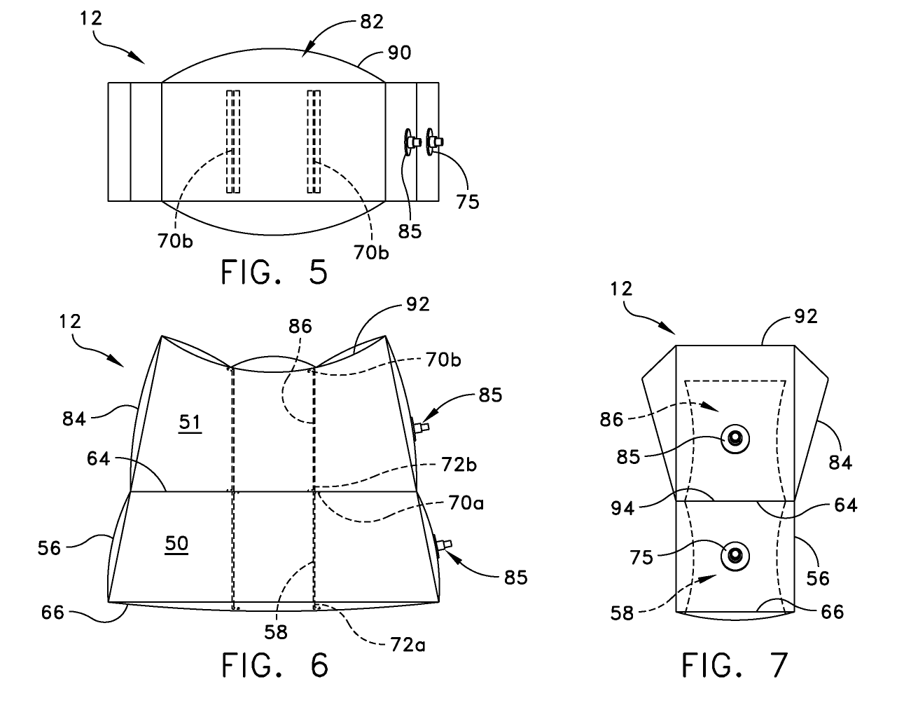

Referring to FIGS. 4-8, a dual-chambered foot rest 12 defines a first air chamber 50 and a second air chamber 51. In some embodiments, first air chamber 50 is formed by arranging together a top panel 52, a bottom panel 54, a perimeter band 56, and a plurality of baffle-panels 58. When employed, top panel 52 is generally rectangular in shape and includes peripheral edge 60. Bottom panel 54 is generally rectangular in shape and includes a peripheral edge 62. Perimeter band 56 often comprises an elongated substantially rectangular strip, having a top edge 64 and bottom edge 66. In preferred embodiments of the invention, bottom panel 54 is somewhat longer than top panel 52, with the widths of top panel 52 and bottom panel 54 being substantially the same size. Perimeter band 56 generally tapers towards the central transverse axis of foot rest 12 so that top edge 64 and bottom edge 66 may be sealingly fastened to peripheral edges 60 and 62, respectively.

Plurality of baffle-panels 58 are located within first air chamber 50, and comprise substantially rectangular sheets of nylon scrim or the like, that include a top edge 70a and a bottom edge 72a. Baffle-panels 58 may have differing or varying widths, depending upon their position within first air chamber 50. Each top edge 70a is fastened (transversely or longitudinally) to a portion of the inner surface of top panel 52, and each bottom edge 72a is fastened (transversely or longitudinally) to a portion of the inner surface of bottom panel 54. Baffle-panels 58 provide strength and stability to foot rest 12 when fully inflated.

Second air chamber 51 comprises a top panel 82, a perimeter band 84, and a plurality of baffle-panels 86. Top panel 82 is often oval in shape, and includes a peripheral edge 90. Perimeter band 84 often comprises an elongate strip, having a curved top edge 92 and straight bottom edge 94. Top edge 92 is often curved to allow foot rest 12 to cradle a patient's lower legs or preferably a patient's heel so as to retain them in a stable position while second air chamber 51 is being inflated. In preferred embodiments of the invention, perimeter band 84 is curved outwardly and away from bottom edge 94 along a longitudinal axis of foot rest 12, so that that top edge 92 and bottom edge 94 may be sealingly fastened to peripheral edges 90 and 60, respectively (FIGS. 6 and 7). Perimeter band 84 tapers inwardly and toward bottom edge 94 along a transverse axis of foot rest 12 (FIG. 6).

Plurality of baffle-panels 86 within second air chamber 51 comprise substantially rectangular sheets of nylon scrim or the like, and include a top edge 70b and a bottom edge 72b. Baffle-panels 86 may have differing or varying widths, depending upon their position within second air chamber 51. Each top edge 70b is fastened (transversely or longitudinally) to a portion of the inner surface of top panel 82, and each bottom edge 72b fastened (transversely or longitudinally) to a portion of the outer surface of top panel 52 of first air chamber 50, but in transversely off-set relation to top edge 70 of baffle panel 58 within bottom chamber 50 so as to facilitate heat sealing or stitching of the respective top and bottom edges.

A pair of inlet/outlet openings 75 and 85 are formed in perimeter bands 56 and 84, respectively, and may be closable openings that sealingly accept an air supply hose 33 (FIG. 4). Inlet openings 75 and 85 are sized and shaped so that air supply hose 33 may be inserted, with the inlet being thereafter snapped shut or otherwise closed to hold air supply hose 33 in place while foot rest 12 is being inflated. Inlet openings 75 and 85 may also include a valve (not shown) that is biased to be normally closed to prevent air from exiting through the inlet, and opened when air supply hose 33 is inserted into inlet opening 75 and 85. Other arrangements known to those skilled in the art may be used to inflate the foot rest 12.

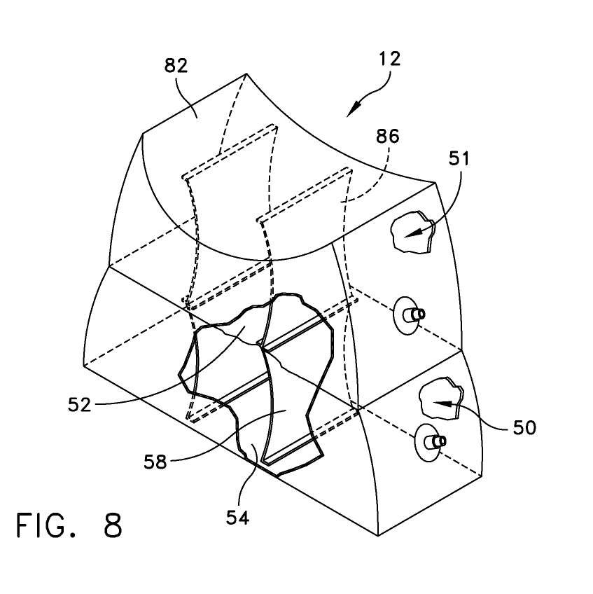

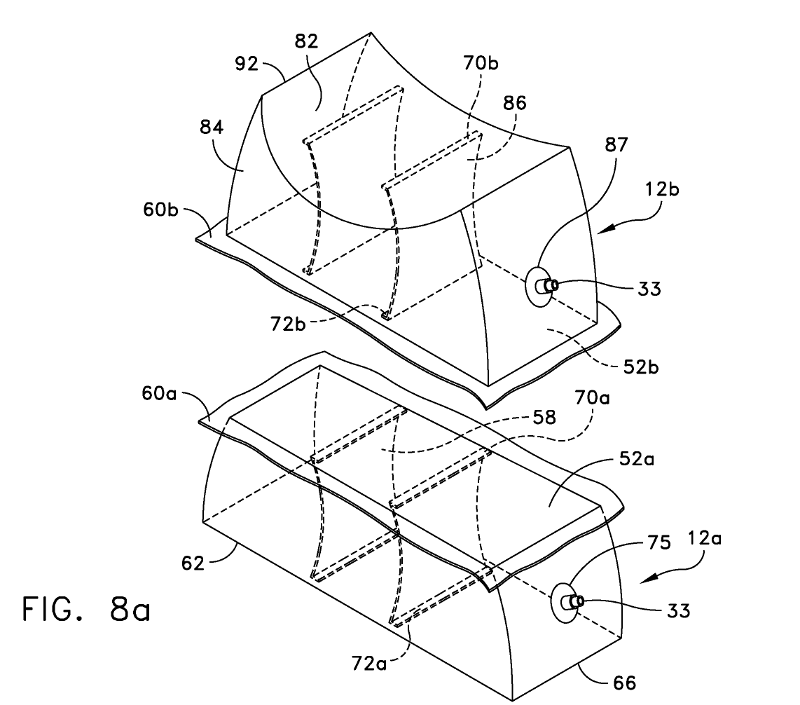

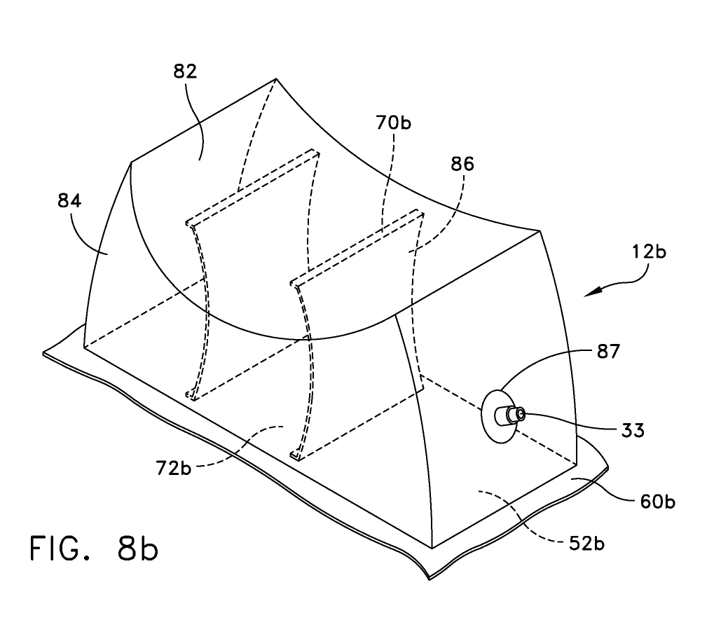

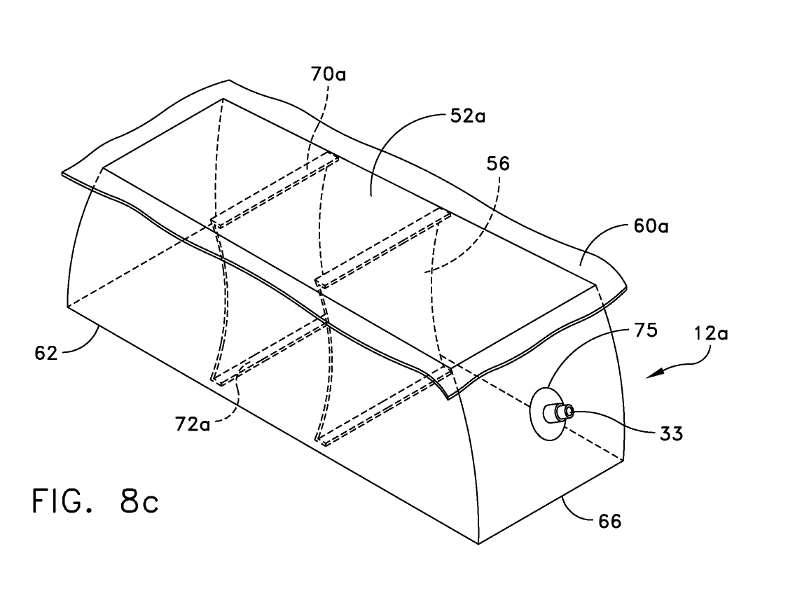

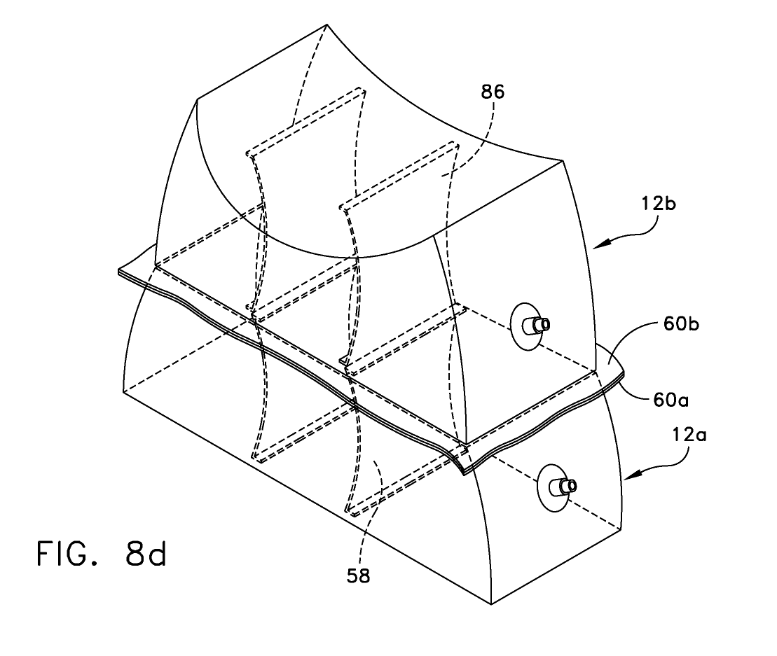

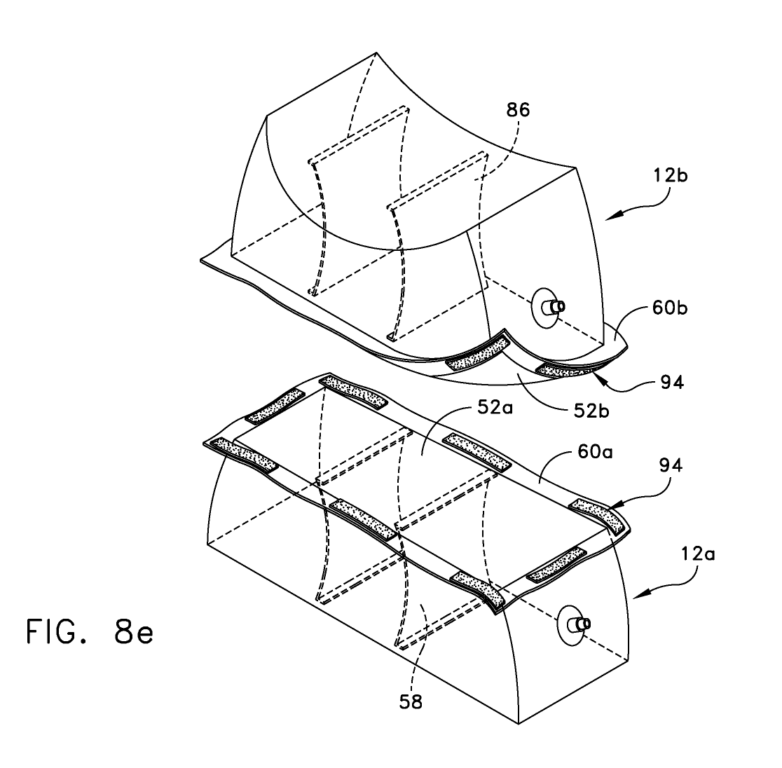

Of course, first air chamber 50 and a second air chamber 51 may be defined by wholly separate cushion structures 12a and 12b that are fastened to one another after assembly (FIGS. 8a-8d). More particularly, Cushions 12a and 12b comprise substantially the same structural elements as dual-chambered foot rest 12, with like parts having like reference numerals in FIGS. 8a-8c. A skirt 60a extends outwardly from top panel 52a of cushion 12a, and a corresponding skirt 60b extends outwardly from bottom panel 52b of cushion 12b. In embodiments in which cushion 12a and cushion 12b are permanently assembled to one another, skirt 60a and skirt 60b are aligned with one another so as to facilitate heat sealing or ultrasonic welding of their interface (FIG. 8d). Any extra material that extends from the newly formed bond may be trimmed and discarded.

Some or all of top panels (4, 52, 82); bottom panels (6, 54); perimeter bands (8, 56, 84); and plurality of baffle-panels (10, 58) are most often, but not always formed from a sheet of fabric, e.g., nylon scrim or the like, and may be coated on at least its outer surface with a water proof coating. The water proof coating may be any of the well known polymeric or elastomeric compounds that are known to be impervious to semi-solids and liquids, such as, blood, urine, feces, hospital strength disinfecting compounds, alcohol, or the like. For example, a nylon twill fabric that is coated on one side with a heat sealable, polyurethane coating (e.g., an inner side) and the outer side coated with a durable water repellant (patient side). A practical benefit associated with the use of the foregoing preferred materials is that transfer mattress 2 retains a better appearance for longer periods of time during use. A double coated transfer mattress 2 can be easily wiped down, and can be put back into use more quickly.

Alternatively, in those instances where a single use, single patient mattress is provided, i.e., where patient use lasting less than twenty-four hours is desired, some or all of top panels (4, 52, 82); bottom panels (6, 54); perimeter bands (8, 56, 84); and plurality of baffle-panels (10, 58) may be formed from fibers or fabrics suitable for single use that are often made of materials, such as, acetate, acrylic, anidex, aramid, azlon, cotton, elastoester, fluorocarbon, fur, glass, lyocell, melamine, metallic, modacrylic, modal, mosacrylic, novoloid, nylon, nytril, olefin, PAN, PBI, PEEK, PEN, PLA, PTT, polyester, polyester-polyarylate, rayon, saran, spandex, sulfar, triacetate, vynal, and wool. A common characteristic of the foregoing and like materials is their propensity to stain or discolor as a result of contact with blood, urine, feces, hospital strength disinfecting compounds, alcohol, or the like. Additionally, a variety of films may be used to form a single patient, single use transfer mattress 2, for example, copolyester, copolyether, ethylene vinyl acetate, fluorocarbon, polyamide, olefins, polybutylene, polycarbonate, polyester, polystyrene, polyurethane, polyvinyl, alcohol, polyvinyl chloride, polyvinyl fluoride, and polyvinylidene chloride. A practical benefit associated with the use of the foregoing preferred materials is that transfer mattress 2 retains a stained and discolored appearance for longer periods of time after use thereby alerting hospital staff or other care givers that a particular transfer mattress 2 has completed its useful life, and must be discarded.

In another embodiment, some portion of top panels (4, 52, 82); bottom panels (6, 54); perimeter bands (8, 56, 84) or the thread that fastens any of the structures together may comprise a cold water soluble partially hydrolyzed polyvinyl alcohol, cold water insoluble hot water disintegrable aliphatic polyester, and minor proportions of processing and performance aids. The aliphatic polyester has a melt temperature above the normal body temperature of a human (37 degrees C.; 98.6 degrees F.) and is present in the resin blend at a concentration sufficient to constitute the continuous phase of the blend, with the polyvinyl alcohol constituting a discontinuous phase of the blend. The aliphatic polyester renders the resin blend, and the partially hydrolyzed polyvinyl alcohol in the blend is cold water insoluble and determines the temperature at which articles formed from the blend will be subject to dissolution in an aqueous bath and subsequent disposal. A practical benefit associated with the use of the foregoing material is that transfer mattress 2 not only retains a stained and discolored appearance for longer periods of time after use, thereby alerting hospital staff or other care givers that a particular transfer mattress 2 has completed its useful life, and must be discarded, but also if an attempt is made to launder the mattress after a single use it disintegrates during the washing process.

A transfer mattress 2 is assembled according to one embodiment of the present invention in the following manner. Bottom panel 6 is laid out on a suitable support surface so that baffle-panels 10 may be longitudinally or transversely arranged on the inner surface of both head portion 14 and foot portion 16. Once in this position, bottom edge 39 of each baffle-panel 10 is fixedly fastened to the inner surface of bottom panel 6. Baffle-panels 10 may be heat sealed along the interface between bottom edge 39 and the inner surface of bottom panel 6 or sewn in a conventional manner. Heat sealing may be done with the application of heat or ultrasonic energy at the edge interface. In this way, a re-solidified interface structure is formed between bottom edge 39 and the inner surface so as to improve the bond and its resistance to rupture under normal loading.

Once plurality of baffle-panels 10 are fastened to the inner surface of bottom panel 6, top panel 4 is arranged in overlying confronting relation with bottom panel 6 so that head portion 14 of top panel 4 is confronting head portion 14 of bottom panel 6. Once in this position, each top edge 37 of each baffle-panel 10 is fixedly fastened to the inner surface of top panel 4. One or more perimeter bands 8 are then positioned between peripheral edge 18 of top panel 4 and peripheral edge 24 of bottom panel 6, and then heat sealed along their interface or sewn in a conventional manner. Here again, heat sealing may be done with the application of heat or ultrasonic energy at the interface between edges. In this way, a re-solidified interface structure is formed so as to improve the bond and its resistance to rupture under normal loading. Alternatively, construction of transfer mattress 2 may be completed by simply sealingly fastening peripheral edge 18 of top panel 4 to peripheral edge 24 of bottom panel 6.

A dual-chambered foot rest 12 is assembled according to one embodiment of the present invention in the following manner. Bottom panel 54 is laid out on a suitable support surface so that baffle-panels 58 may be longitudinally or transversely arranged on the inner surface of the bottom panel 54. Once in this position, bottom edge 72a of each baffle-panel 58 is fixedly fastened to the inner surface of bottom panel 54. Baffle-panels 58 may be heat sealed along the interface between bottom edge 72a and the inner surface of bottom panel 54 or sewn in a conventional manner. Heat sealing may be done with the application of heat or ultrasonic energy at the edge interface. In this way, a re-solidified interface structure is formed between bottom edge 72a and the inner surface so as to improve the bond and its resistance to rupture under normal loading.

Once plurality of baffle-panels 58 are fastened to the inner surface of bottom panel 54, top panel 52 is arranged in overlying confronting relation with bottom panel 54. Once in this position, each top edge 70a of each baffle-panel 58 is fixedly fastened to the inner surface of top panel 52. One or more perimeter bands 56 are then positioned between peripheral edge 60 of top panel 52 and peripheral edge 62 of bottom panel 54, and then heat sealed along their interface or sewn in a conventional manner. Here again, heat sealing may be done with the application of heat or ultrasonic energy at the interface between edges. In this way, a re-solidified interface structure is formed so as to improve the bond and its resistance to rupture under normal loading. Alternatively, construction of first air chamber 50 may be completed by simply sealingly fastening peripheral edge 60 of top panel 52 to peripheral edge 62 of bottom panel 54.

First air chamber 50 is then oriented so that baffle-panels 86 may be longitudinally or transversely arranged on the outer surface of top panel 52. Once in this position, bottom edge 72b of each baffle-panel 86 is fixedly fastened to the outer surface of top panel 52 in transversely off-set relation to top edge 70a of baffle panel 58 so as to allow for appropriate engagement with the fixation equipment. Baffle-panels 86 may be heat sealed along the interface between bottom edge 72b and the outer surface of top panel 52 or sewn in a conventional manner. Heat sealing may be done with the application of heat or ultrasonic energy at the edge interface. In this way, a re-solidified interface structure is formed between bottom edge 72b and the inner surface so as to improve the bond and its resistance to rupture under normal loading.

Once plurality of baffle-panels 86 are fastened to the outer surface of top panel 52, top panel 82 is arranged in overlying confronting relation with top panel 52. Once in this position, each top edge 70b of each baffle-panel 86 is fixedly fastened to the inner surface of top panel 82 (FIG. 4). One or more perimeter bands 84 are then positioned between peripheral edge 60 of top panel 52 and peripheral edge 90 of top panel 82, and then heat sealed along their interface or sewn in a conventional manner. Here again, heat sealing may be done with the application of heat or ultrasonic energy at the interface between edges. In this way, a re-solidified interface structure is formed so as to improve the bond and its resistance to rupture under normal loading. Alternatively, construction of second air chamber 51 may be completed by simply sealingly fastening peripheral edge 90 of top panel 82 to peripheral edge 60 of bottom panel 52.

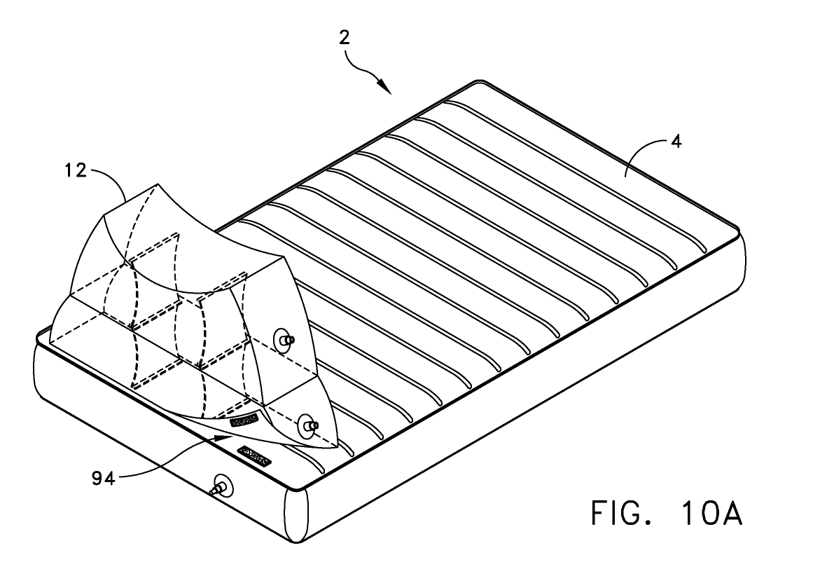

Referring again to FIG. 1, in one embodiment foot rest 12 is attached to top panel 4 in the following manner. Bottom panel 54 of foot rest 12 is arranged in overlying confronting relation with the outer surface of foot portion 16 near peripheral edge 18. Bottom panel 54 is generally centered about the longitudinal axis of top panel 4. The longitudinal axis of bottom panel 54 is aligned parallel to the transverse axis of top panel 4. Once in this position, peripheral edge 62 is heat sealed along or sewn in a conventional manner to the outer surface of top panel 4. Here again, heat sealing may be done with the application of heat or ultrasonic energy at the interface between edges. In this way, a re-solidified interface structure is formed so as to improve the bond and its resistance to rupture under normal loading. Alternatively, foot rest 12 may be releasably fastened to top panel 4 through the use of corresponding sets of snaps located on foot rest 12 and top panel 4 or hook and felt fasteners 94 arranged in a similar manner (FIG. 10a). In a further alternative embodiment, cushion 12a and cushion 12b may be releasably assembled to one another via hook and felt fasteners 94 arranged in complementary locations on the outer surfaces of skirt 60a and skirt 60b (FIG. 8e).

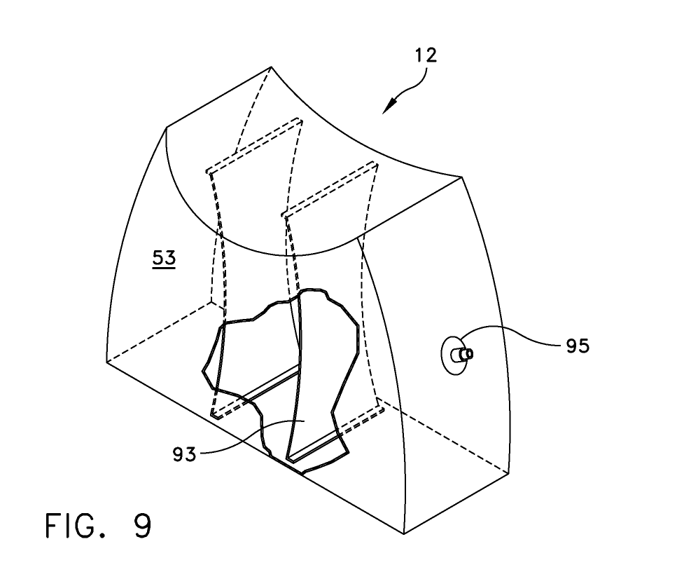

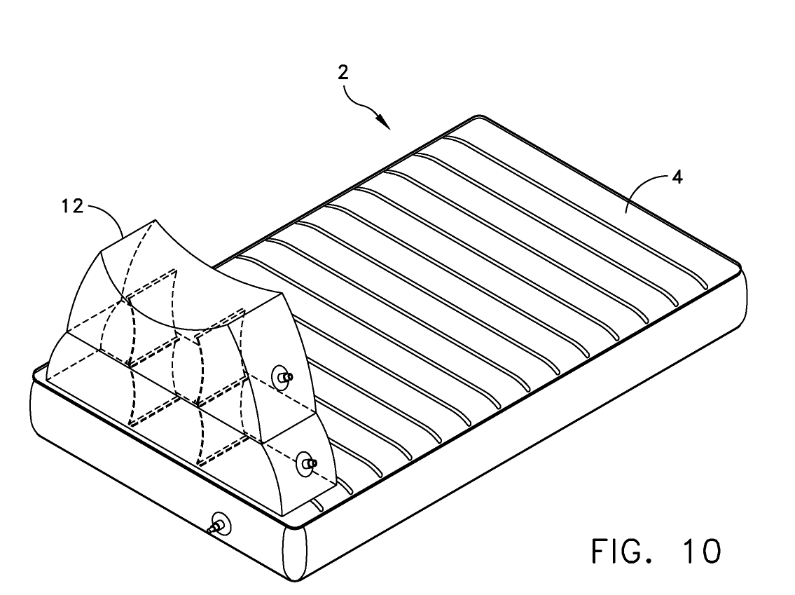

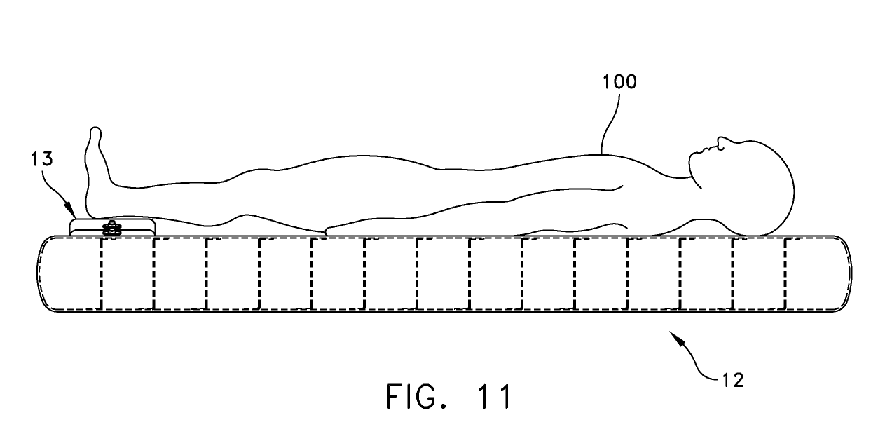

According to one embodiment of the invention, foot rest 12 may define a single air chamber 53 housing one or more baffle-panels 93 and an inlet/outlet opening 95 (FIG. 9). The overall construction and proportions of air chamber 53 is similar to that of dual-chambered foot rest 12. Depending upon the size of the patient's leg, a single air chamber 53 may be preferred over the dual-chambered design. In accordance with a further embodiment of the invention, foot rest 12 may extend the transverse distance across top panel 4 (FIG. 10). The embodiment may provide additional height to foot rest 12, and increase stability and support to the patient's legs. According to one other embodiment of the invention, a transfer mattress 2 may be used to position or transfer patients to and from therapeutic procedures as follows (FIGS. 3 and 11). With air supply hose 33 positioned within opening 31, pressurized air is forced into transfer mattress 2. Inflation of transfer mattress 2 may be accomplished with or without a patient 100 positioned on outer surface of top panel 4 (FIGS. 3 and 11). Patient 100 may be placed on transfer mattress 2 before or after inflating has begun or is completed.

Preferably, patient 100 is positioned on transfer mattress 2 when foot rest 12 is in a deflated state 13 (FIG. 11). After positioning the heel of at least one foot on foot rest 12, air supply hose 33 is positioned within inlet/outlet openings 75,85. Then pressurized air is forced into first air chamber 50 and second air chamber 51, respectively. Air chambers 50,51 may be partially filled depending upon the desired height of the patient's legs. After filling air chambers 51,52 inlet/outlet openings 75,85 may be closed in order to hold the patient's leg at a desired height for a time.

In accordance with a further embodiment of the invention, transfer mattress 2 may be used when the physical act of positioning or transferring a patient 100 is completed, as follows. Patient 100 is positioned atop the outer surface of transfer mattress 2 so that the patient's head is resting on top panel 4 and the heel of at least one foot of the patient is positioned on top of foot rest 12. Foot rest 12 is inflated by passing pressurized air through at least one inlet/outlet openings 75,85, thereby raising at least one foot of the patient. Transfer mattress 2 is inflated by passing pressurized air through opening 31 in perimeter band 8. Transfer mattress 2 may be inflated with air flowing through holes 41 so as to effect the cushion of air necessary for transfer of patient 100. It will be understood that this sequence of inflation is arbitrary and that either the transfer mattress 2 or the foot rest 12 may be inflated first. Although the human knee, ankle and foot joints permit a very wide range of positioning of the foot with respect to the leg, obese patients pose unique problems. Foot rest 12 supports the heel of obese patient 100 such that easy positioning of the patient is accomplished while maintaining constant leg elevation, and particularly where only the heel of the patient can be supported as a result of the need by the clinician to access the entire leg of the patient.

Once inflated, transfer mattress 2 is shifted laterally from a first surface to a second surface. Once on the second surface, supply air ceases to flow through inlet opening 31 and air is allowed to escape through the holes 41 due to the weight of the patient. Advantageously, air does not escape from foot rest 12 so that the patient's legs remain in an elevated position. It may be appreciated that the foot rest may be used without transferring or positioning the patient.

It is to be understood that the present invention is by no means limited only to the particular constructions herein disclosed and shown in the drawings, but also comprises any modifications or equivalents within the scope of the claims.

What is claimed is:

1. An inflatable mattress comprising:
a top panel having a top surface;
a bottom panel having a plurality of perforations defined therethrough, said bottom panel being sealingly assembled to said top panel; and
an inflatable foot rest located on said top surface and suitable for raising the heel of at least one leg of a patient when the patient is lying upon said top panel.

2. An inflatable mattress according to claim 1 wherein said inflatable foot rest comprises a top panel, a bottom panel, and a perimeter band arranged so as to define a first air chamber and second air chamber within said inflatable footrest.

3. An inflatable mattress according to claim 2 wherein said top panel is rectangular in shape and includes peripheral edge, said bottom panel is rectangular in shape and includes a peripheral edge, and said perimeter band comprises an elongate strip, having a top edge sealingly fastened to a peripheral edge and bottom edge sealingly fastened to a peripheral edge.

4. An inflatable mattress according to claim 3 wherein said perimeter band tapers toward a central transverse axis so that said top edge and said bottom edge of said perimeter band may be sealingly fastened to said peripheral edges of said top panel and said bottom panel.

5. An inflatable mattress according to claim 2 further comprising a plurality of baffle-panels located within said first air chamber, and comprising a top edge and a bottom edge such that said top edge is fastened to a portion of said top panel, and said bottom edge is fastened to a portion of said bottom panel as to provide strength and rigidity to said inflatable foot rest.

6. An inflatable mattress according to claim 5 further comprising a plurality of baffle-panels located within said second air chamber, and comprising a top edge and a bottom edge such that said top edge is fastened to a portion of said top panel, and said bottom edge is fastened to a portion of said bottom panel as to provide strength and rigidity to said inflatable foot rest.

7. An inflatable mattress according to claim 3 wherein said perimeter band comprises an elongate strip, having a curved top edge and straight bottom edge so as to cradle a patient's lower legs and feet.

8. An inflatable mattress according to claim 7 wherein said perimeter band is curved outwardly and away from said bottom edge so that that said top edge and said bottom edge may be sealingly fastened to said peripheral edges.

9. An inflatable mattress according to claim 4 wherein said perimeter band tapers inwardly and toward said bottom edge.

10. An inflatable mattress according to claim 1 wherein said inflatable foot rest includes a pair of inlet/outlet openings formed in said perimeter bands that are sized and shaped to receive an air supply hose.

11. An inflatable mattress according to claim 1 wherein said inflatable foot rest is removable from said mattress.

12. An inflatable foot rest suitable for raising the heel of at least one leg of a patient, said inflatable foot rest comprising:
a top panel, a bottom panel, and a perimeter band having a top edge and a bottom edge, and arranged so as to define a first air chamber and second air chamber within said inflatable footrest, and further wherein said perimeter band tapers toward a central transverse axis so that said top edge and said bottom edge of said perimeter band may be sealingly fastened to said peripheral edges of said top panel and said bottom panel.

13. An inflatable foot rest according to claim 12 wherein said perimeter band tapers toward a central transverse axis so that said top edge and said bottom edge of said perimeter band may be sealingly fastened to said peripheral edges of said top panel and said bottom panel.

14. An inflatable foot rest according to claim 13 further comprising a plurality of baffle-panels located within said first air chamber, and comprising a top edge and a bottom edge such that said top edge is fastened to a portion of said top panel, and said bottom edge is fastened to a portion of said bottom panel as to provide strength and rigidity to said inflatable foot rest.

15. An inflatable foot rest according to claim 14 further comprising a plurality of baffle-panels located within said second air chamber, and comprising a top edge and a bottom edge such that said top edge is fastened to a portion of said top panel, and said bottom edge is fastened to a portion of said bottom panel as to provide strength and rigidity to said inflatable foot rest.

16. An inflatable foot rest according to claim 15 wherein said perimeter band comprises an elongate strip, having a curved top edge and straight bottom edge so as to cradle a patient's lower legs and feet.

17. An inflatable foot rest according to claim 16 wherein said perimeter band is curved outwardly and away from said bottom edge so that that said top edge and said bottom edge may be sealingly fastened to said peripheral edges.

18. An inflatable foot rest according to claim 17 wherein said perimeter band tapers inwardly and toward said bottom edge.

19. A method for raising the legs of a patient comprising:
(A) positioning a transfer mattress on a surface suitable for supporting a patient wherein said transfer mattress;
(B) locating a foot rest suitable for raising the legs of a patient when the patient is lying upon said transfer mattress,
(C) positioning a patient on said transfer mattress so that the heels of the patient's legs are generally on said foot rest; and
(D) inflating said foot rest.

20. A method for transferring a patient comprising:
(A) positioning a transfer mattress on a surface suitable for supporting a patient wherein said transfer mattress comprises a foot rest suitable for raising the legs of a patient when the patient is lying upon said mattress;
(B) positioning a patient on said transfer mattress so that the heels of the patient's legs are generally on said foot rest;
(C) inflating said transfer mattress; and
(D) transferring the patient on said transfer mattress.

21. A method for transferring a patient according to claim 19 further comprises the step of inflating said foot rest after the positioning step.

22. An inflatable mattress comprising:
a top panel having a top surface;
a bottom panel having a plurality of perforations defined therethrough, said bottom panel being sealingly assembled to said top panel; and
an inflatable foot rest located on said top surface and suitable for raising the heel of at least one leg of a patient when the patient is lying upon said top panel wherein said inflatable foot rest comprises at least two separate cushions one stacked upon the other.
